(19) United States
(12) Patent Application Publication
(10) Pub. No.: US 2016/0352145 A1
(43) Pub. Date: Dec. 1, 2016

(54) Wireless Power Transfer for Process Control

(71) Applicant: Henry William Boger, Hoover, AL (US)

(72) Inventor: Henry William Boger, Hoover, AL (US)

(21) Appl. No.: 14/726,551

(22) Filed: May 31, 2015

(51) Int. Cl. H02J 50/10

(52) U.S. Cl. CPC H02J 50/10

(57) ABSTRACT

A system and method for wireless power transfer for process control devices is disclosed. The control devices may be process transmitters, or process control valves equipped with digital valve controllers (valve positioners).

### BACKGROUND

This disclosure relates to process control, and, in particular to process control of fluids. Process transmitters and fluid regulators (e.g., valves) are used in a wide variety of environments for both commercial and industrial applications. For example, fluid regulators can be used to regulate fluids in pipeline systems, chemical plants, and building environmental systems. Regardless of environment or application, many fluid regulators are controlled by some type of logic-driven controller, whether located with or remote to the fluid regulator. A controller allows a fluid regulator to be operated in an intelligent manner to achieve one or more defined performance measures (e.g., flow rate, pressure, temperature, level, etc.).

The traditional method for operation of a fluid regulator with a digital controller is to receive an electrical current position signal (normally 4 to 20 milliamperes), and to bootstrap a small amount of energy to operate a microprocessor and electronic elements.

Wiring costs are a driving force toward the use of wireless technology. While position signals may be transmitted wirelessly, power is normally supplied be one or more batteries. These batteries must be replaced on a regular basis depending upon cycle time. An environmental benefit is reducing the need to dispose of 6 billion batteries each year.

### SUMMARY

The disclosed system and method is based upon wireless power transfer. The technology uses microwaves to transfer power wirelessly. The source of power is equipped with a transmitting antenna, and the process device is equipped with a receiving antenna.

### BRIEF DESCRIPTION OF THE DRAWINGS

FIG. 1 is block diagram of a closed control loop.

FIG. 2 is a block diagram as an example of wireless power transfer as applied to powering a digital valve controller from a power source associated with a process controller.

### DETAILED DESCRIPTION

Wireless power transfer can be achieved for medium to far distances by the use of microwaves. Microwave energy is focused on a location by a power transmitter having one or more adaptively-phased microwave emitters. Rectennas within the device to be powered receive and rectify microwave energy for use as primary power.

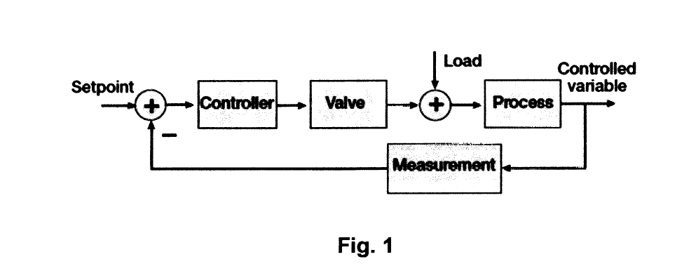

FIG. 1 is a block diagram of a closed control loop. The loop is closed because of feedback of the measurement of the controlled variable. The measurement block is commonly known as a process transmitter. The summation block calculates the error between setpoint and measurement. The controller acts on the error using a PID control algorithm to establish an updated position signal to the valve positioner. The valve throttles flow, affecting the process, as well as load disturbances. The measurement of the controlled variable is updated and the process starts over again.

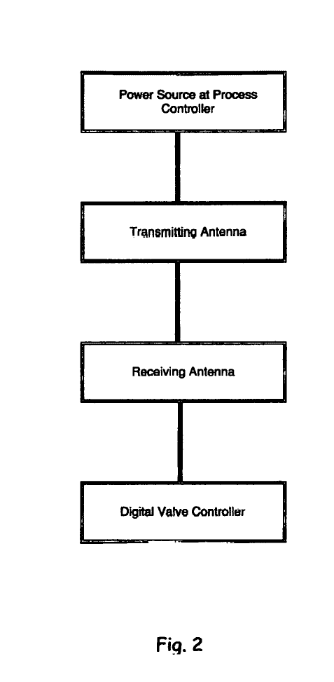

FIG. 2 illustrates a system for wireless power transfer. A power source at the process controller feeds a transmitting microwave antenna. The microwave energy is acquired by a receiving antenna, and is rectified in order to produce power for the operation of a digital valve controller (positioner).

What is claimed is:

1. A system including a process controller equipped with a wireless power transmitting antenna and a process control valve equipped with a wireless power receiving antenna.

2. A system including a process transmitter equipped with a wireless power transmitting antenna and a process controller equipped with a wireless power receiving antenna.

3. A method including process controller equipped with a wireless power transmitting antenna and a process control valve equipped with a wireless power receiving antenna.

4. A method including a process transmitter equipped with a wireless power transmitting antenna and a process controller equipped with a wireless power receiving antenna.
